(19) United States
(12) Patent Application Publication
(10) Pub. No.: US 2004/0046786 A1
(43) Pub. Date: Mar. 11, 2004

(54) Server device and management method of network apparatus by the server device

(75) Inventor: Yoshifumi Tanimoto, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: MURATA KIKAI KABUSHIKI KAISHA, Kyoto-shi (JP)

(21) Appl. No.: 10/653,916

(22) Filed: Sep. 4, 2003

(30) Foreign Application Priority Data
Sep. 9, 2002 (JP) 2002-262264

(51) Int. Cl. G09G 5/00; G06F 15/173

(52) U.S. Cl. 345/736; 709/223

(57) ABSTRACT

To provide a server device which can uniformly manage various types of network apparatuses, and which can easily carry out a management configuration for operating the network apparatuses by linking the network apparatuses. A display control unit arranges icons indicating the network apparatuses on layout image, and displays the layout image on the display unit in accordance with configuration information. An operation unit accepts an operation to configure management information by triggering icons by a user. In accordance with the operation accepted by the operation unit, the configuration unit carries out a management configuration of the network apparatuses, and registers/updates the configuration information. In addition, an instruction to change the configuration information is transmitted automatically to the related network apparatuses.

### FIELD OF THE INVENTION

The present invention relates to a server device and method which manage various types of apparatus connected to a network.

### DESCRIPTION OF THE RELATED ART

In recent network technology developments, various network apparatus are connected by a network such as a Local Area Network (LAN), thus enabling information to be exchanged among apparatuses connected to the network. For example, in an office, a plurality of terminal apparatuses such as a personal computer and a workstation, input/output devices such as a scanner and a printer, and various server apparatuses such as a file server, a mail server, and a facsimile server are connected to the LAN.

When many network apparatuses are used as described above, it is necessary to manage them so that they can operate properly. However, to manage each of the network apparatuses separately, it is necessary to carry out a configuration for each of the network apparatuses. As a result, the configuration process becomes extremely complicated. Therefore, there are demands for development of a system which reduces such a burden on management.

Conventionally, as a system which manages a plurality of apparatuses, there is a system which provides a management server for specific types of apparatus such as a printer, a facsimile machine or the like. The management server can manage a plurality of apparatuses. However, in such a system, only specific types of apparatus can be managed. For example, in a system which manages a printer, when the management server carries out a configuration at a client site which transmits information to the printer, the configuration at the client site could not be carried out in the same way as the configuration of the printer at a home site, and it was necessary to carry out the configuration at the client site differently. In addition, in a system which manages facsimile machines, a state or the like of each of the facsimile machines can be managed, but it was necessary to carry out a configuration at a client site which requests a facsimile transmission and receives a distribution of image received by the facsimile at the client site differently, separately from the management of the facsimile machines at the home site.

Moreover, there is a system in which various types of peripheral devices, such as a printer or a scanner, are displayed as icons. Under this system, only the newest state of each of the peripheral devices are displayed, and various managements and a configuration of the managements for the various types of devices could be carried out by a unified operation of the icons.

As described above, there are problems in that different types of terminals cannot be managed uniformly, and a configuration of various management information for operating different types of terminal by linking each of the terminals cannot be carried out.

### SUMMARY OF THE INVENTION

An advantage of the present invention is to provide a server device which can uniformly manage various types of network apparatuses, and which can easily carry out various management configurations for operating the network apparatuses by linking the network apparatuses.

According to a first aspect of the present invention, the server device which manages various types of network apparatuses include a display unit, a display control unit, an operation unit, and a configuration unit. The display control unit arranges icons indicating the network apparatuses on layout image and displays the layout image on the display unit according to a state of a configuration. The operation unit accepts an operation triggered by a user on one or more icons. The configuration unit configures management information of the network apparatus in accordance with the operation. Under such an architecture, the user can easily carry out a management configuration by operating the icons.

As the management configuration, for example, the network apparatus corresponding to an icon selected in accordance with an operation for selecting a range can be configured as a distribution destination of information. As another example, in accordance with an operation to associate an icon corresponding to a certain network apparatus with an icon corresponding to a certain server apparatus, a configuration can be carried out to register the network apparatus as a client of the server apparatus. Moreover, as another example, a configuration can be carried out to group the network apparatuses corresponding to the icons selected in accordance with an operation for selecting a range of icons.

Moreover, according to a second aspect of the present invention, when displaying on the display unit by the display control unit, in accordance with a configuration of groups, an icon corresponding to a network apparatus belonging to a different group can be displayed under a different form, and a plural number of groups can be displayed at the same time. In addition, a distribution route of the information can be displayed on the display unit, or a distribution history of the information can be displayed on the display unit.

### BRIEF DESCRIPTION OF THE DRAWINGS

FIG. 1 shows an example of a network system which includes a server device according to an embodiment of the present invention.

FIG. 2 shows an example of a display in a central server 11 before an operation.

FIG. 3 shows an example of a display screen when configuring a group.

FIG. 4 shows an example of a display screen when grouping.

FIG. 5 shows an example of a display screen when configuring a destination.

FIG. 6 shows an example of a screen for a condition configuration when configuring the destination.

FIG. 7 shows an example of a display of distribution routes.

FIG. 8 shows an example of a display of a distribution history.

FIG. 9 shows an example of a display screen when registering a client.

FIG. 10 shows an example of a screen for a user configuration when registering a client.

FIG. 11 shows an example of a display screen when configuring a storage device for a scanned original document.

FIG. 12 shows an example of a screen for a folder configuration when configuring the storage device for the scanned original document.

FIG. 13 shows an example of a screen which shows an operation to configure management information between a plurality of layout images.

### DETAILED DESCRIPTION OF THE PREFERRED EMBODIMENTS

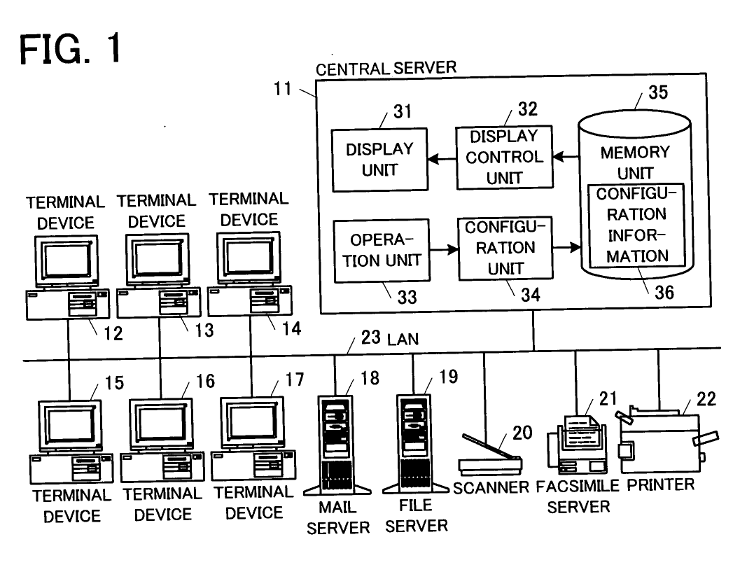

FIG. 1 shows an example of a network system which includes a server device according to an embodiment of the present invention. In the drawing, reference number 11 is a central server, 12˜17 are terminal devices, 18 is a mail server, 19 is a file server, 20 is a scanner, 21 is a facsimile server, 22 is a printer, 23 is a Local Area Network (LAN), 31 is a display unit, 32 is a display control unit, 33 is an operation unit, 34 is a configuration unit, 35 is a memory unit, and 36 is configuration information. In the example shown in FIG. 1, the central server 11 which is the server device of the present invention, and network apparatus such as the terminal devices 12˜17, the mail server 18, the file server 19, the scanner 20, the facsimile server 21, the printer 22 or the like are connected to the LAN 23. Moreover, various apparatuses can be connected to the LAN, and the present invention is not limited to the above example.

The central server 11 manages these various network apparatuses. The central server 11 includes the display unit 31, the display control unit 32, the operation unit 33, the configuration unit 34, the memory unit 35 or the like to implement management functions. The display unit 31 is a display device which presents various information to a user of the central server 11 in accordance with control of the display control unit 32. A method for displaying the information can be determined optionally.

For example, in accordance with a configuration state stored in the memory unit 35 as the configuration information 36, the display control unit 32 arranges in image of an office layout, icons which represent network apparatuses. Then, the display control unit 32 displays the image on the display unit 31. Each of the icons can be displayed by changing a displaying method such that each of various management information can be distinguished. For example, when the network apparatuses are divided into groups, an icon corresponding to a network apparatus which belongs to a different group can be displayed under a different form. As a result, when a plural number of groups are displayed at the same time, the network apparatus of each of the groups can be displayed to be visually distinguishable.

Moreover, for example, when information is distributed, a distribution route of the information can be displayed with an arrow or the like on the display unit 31. In addition, a distribution history can be displayed so that it can be grasped visually, to which network apparatus the information was distributed, and to which network apparatus the information failed to be distributed. Furthermore, various displays can be carried out as shown in the following examples. Of course, various well-known displaying methods can also be applied for the displaying method.

The operation unit 33 accepts operations carried out by the user. In particular, the operation unit 33 accepts operations carried out to the icons which represent the network apparatus displayed on the display screen of the display unit 31. For example, the operation unit 33 can accept operations such as a switching between selection/non-selection of the icons, a selection of the icons by designating a range, and an operation to associate by drag and drop.

The configuration unit 34 carries out a management configuration of the network apparatus in accordance with the operation carried out by the user that is accepted at the operation unit 33. At this time, according to the management configuration, the change in the configuration can be notified to each of the relating network apparatuses, and the configuration in each of the network apparatuses can be changed automatically. As an example of the management configuration, the network apparatus corresponding to the selected icon can be configured as a distribution destination of the information, or can be grouped. Moreover, in accordance with an operation which associates an icon corresponding to a certain network apparatus with an icon corresponding to a certain server apparatus, the network apparatus can be registered as a client of the server apparatus. Details of these examples will be described later.

The memory unit 35 stores various information, programs or the like which are necessary to be stored in the central server 11. In particular, the memory unit 35 stores the configuration information 36 for managing each of the network apparatuses. The configuration information 36 includes various information relating to the network apparatuses to be managed by the central server 11, and various information which associate with the network apparatuses. The configuration information 36 is registered and updated by the configuration unit 34, and indicates the configuration state within the system of that time. The memory unit 35 can also store image which indicates an office layout, a distribution history of when the information is distributed, and various other information.

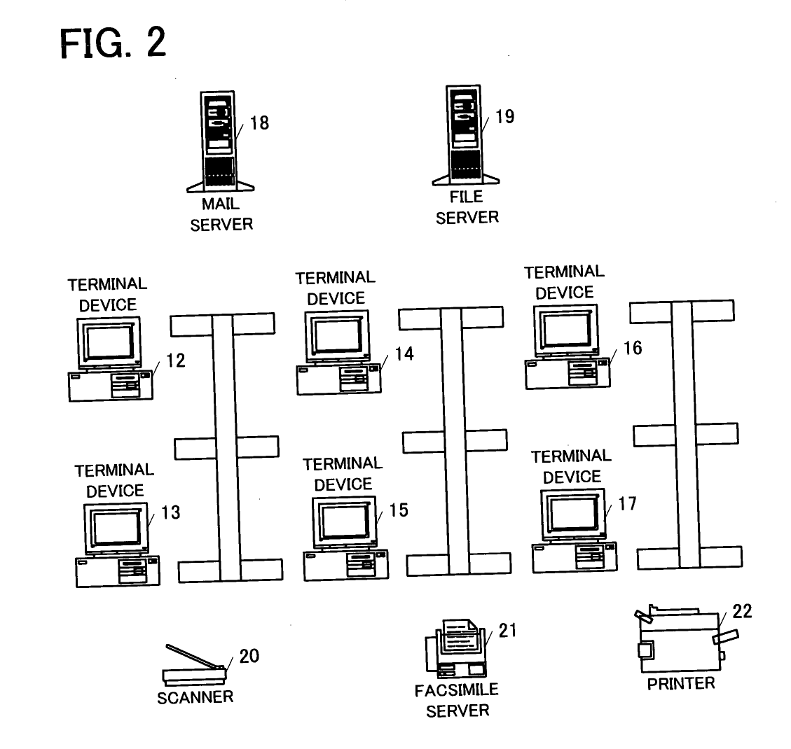

Next, based on the example of the above-described system, specific examples of carrying out various management configurations in the central server 11 will be described. FIG. 2 shows an example of a display of the central server 11 before an operation. The display control unit 32 arranges the icons indicating the network apparatus on image of an office layout or the like, in accordance with the configuration information 36 stored in the memory unit 35. Then, the display control unit 32 displays the image on the display unit 31. An example of the screen displayed on the display unit 31 is shown in FIG. 2. Desks are arranged, and the icons corresponding to various network apparatuses shown in FIG. 1 are arranged.

The icons of the network apparatuses which are generally provided in an office environment, such as the terminal devices 12˜17, the scanner 20, the facsimile server 21, the printer 22 or the like, can be displayed at a position close to the position where the network apparatuses are provided in the office. Further, the central server 11 is not displayed. Of course, the central server 11 can certainly be displayed somewhere on the screen. Moreover, the display screen can also display various display information, such as a menu bar for selecting various functions, in addition to the display shown in FIG. 2. Furthermore, this display can be displayed as one window, and can be displayed along with another window. The displaying method can be any method.

Further, the screen as shown in FIG. 2 can be formed by selecting or generating a layout image, registering a network apparatus by adding and arranging each icon, or deleting the registration of a network apparatus by deleting an icon. The layout image can be drawn, or image such as image scanned by a scanner or image photographed by a digital camera or the like can be used for the layout image. Moreover, regarding the icons corresponding to each of the network apparatuses, an icon provided in advance can be used, or the user can form an icon. Alternatively, the central server 11 can recognize the network apparatus automatically, and generate a corresponding icon automatically.

Moreover, for example, when managing a plurality of network apparatuses, the number of icons increase, and it becomes difficult to distinguish each of the icons. Therefore, the central server 11 can include a function for displaying the layout image by zooming-up a part of the layout image, or include a function for displaying the layout image by zooming-down when it is necessary to refer to the entire layout image. Furthermore, the central server 11 can include a function for displaying only the network apparatus that match with various conditions, such as an installation location, or a group to be described later. The screen can display the layout image partially. For example, when an office is formed from three stories, the screen can display only the first floor, or only the second and the third floors. Alternatively, the screen can display a department where the network apparatus is installed. Moreover, when using several layout images, the icons corresponding to the network apparatus can be arranged on each of the layout images, and the management configuration can be carried out by switching the layout images.

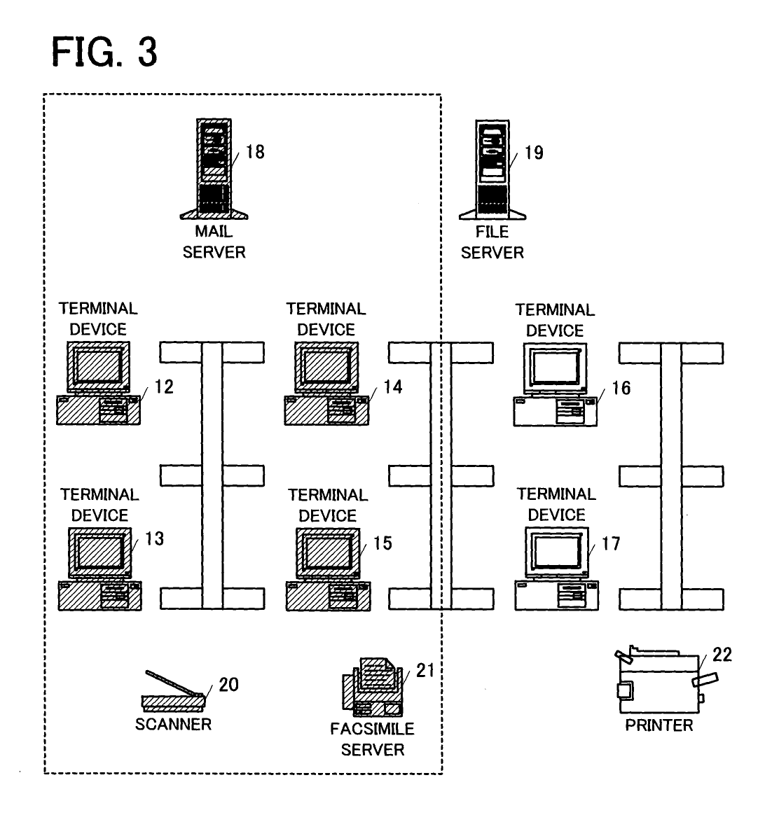

Under a state in which such a basic display is carried out, various management configurations can be carried out by instructing from a menu (not shown in the drawings) or the like. FIG. 3 shows an example of a display screen when configuring a group. The group configuration can be used for various purposes. For example, the configured group can be used to limit a usage of the network apparatus, used as a unit for charging, or used to configure a distribution destination as to be described later. When configuring a group, under a state in which a basic display as shown in FIG. 2 is carried out, the network apparatus to be grouped can be selected, and an instruction to configure a group can be carried out.

Alternatively, the instruction to configure a group can be carried out first, and then, the network apparatus can be selected, and an instruction to execute the group configuration can be carried out. The network apparatus can be selected one by one, or can be selected in groups by selecting a range (in FIG. 3, the range is shown by a dashed-lined rectangle). The selected icons can be displayed in a different form. For example, color or brightness of the icons can be changed. In FIG. 3, for the convenience of indicating by drawing, the selected icons are shown with hatchings. Moreover, the network apparatus to be grouped are not limited to terminal devices 12˜17, and various network apparatuses can be selected and grouped at the same time.

For example, such a grouping can be carried out for a unit of departments in an office. By the above-described grouping, in addition to the terminal devices, various network apparatuses such as a facsimile server, a printer, or a scanner can be registered with a group of each department. Further, it can be constructed such that department codes or the like can be registered as information for specifying a group.

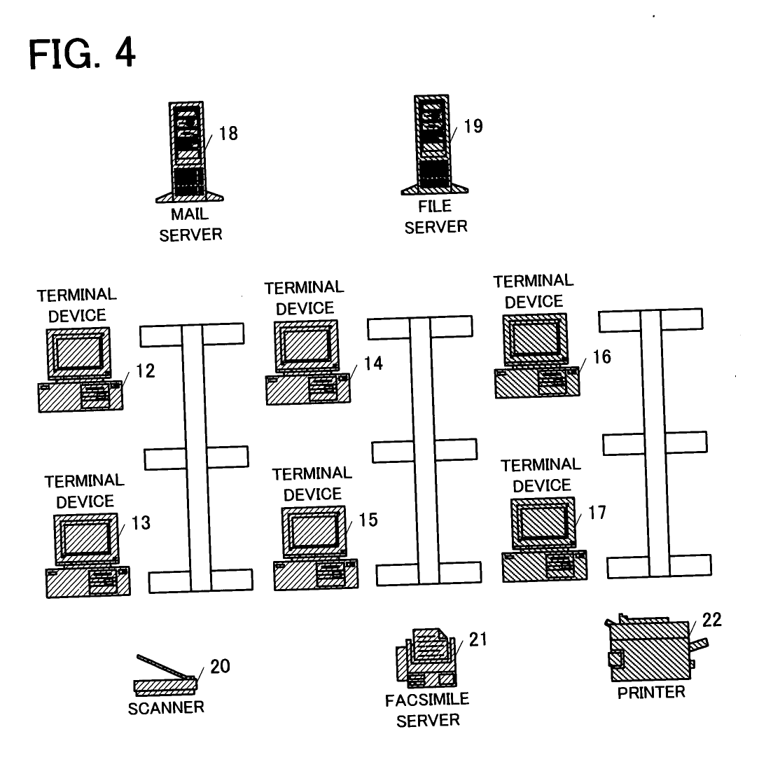

FIG. 4 shows an example of a display screen when grouping. When several groups are configured as described above, it is preferable for the network apparatus belonging to each of the groups to be visually distinguishable. In FIG. 4, two groups are configured, and the network apparatus belonging to each of the groups are displayed under different forms, for example, by changing the colors. Further, in FIG. 4, for the convenience of indicating by drawing, each of the groups is distinguished by differences in hatchings. By referring to such a display screen, it can be grasped visually which network apparatus belongs to which group. Further, from the screen which is displayed according to the group, an operation can be carried out to change the group which each of the network apparatuses belongs, or to combine or divide the groups.

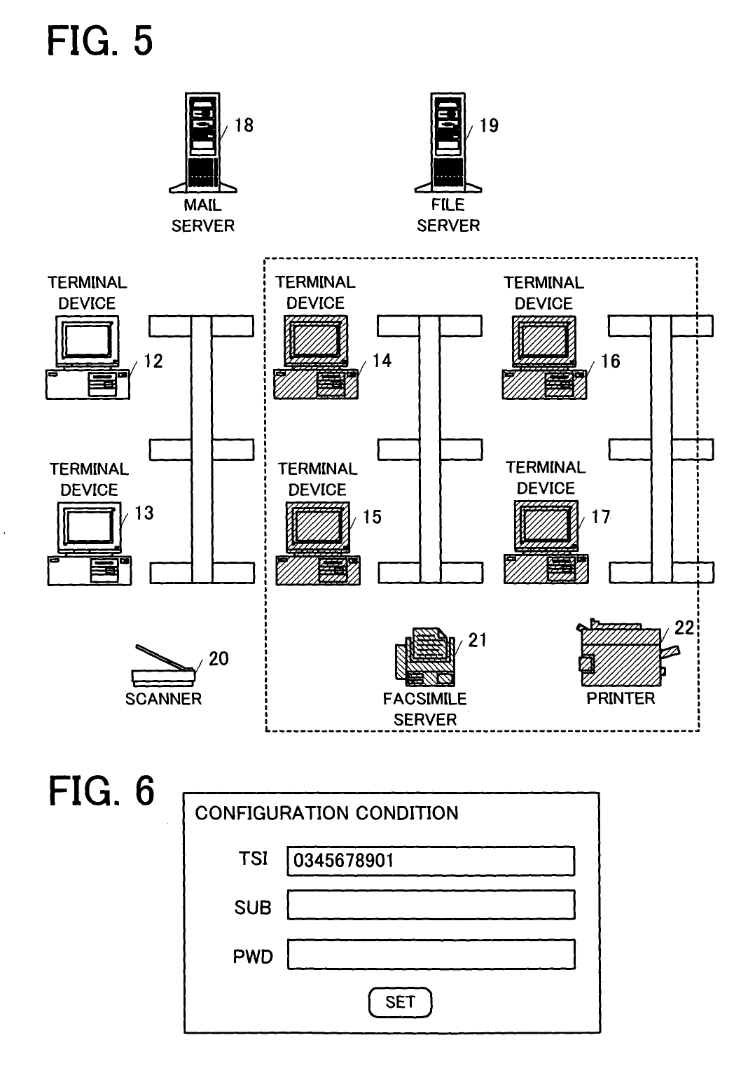

FIG. 5 shows an example of a display screen when configuring a distribution destination. FIG. 6 shows an example of a screen for setting up a condition when configuring the distribution destination. In the same manner as the above-described group configuration, the distribution destination when distributing the information can be set-up. For example, when configuring the distribution destination of facsimile image received by the facsimile server 21, under a state in which a basic display as shown in FIG. 2 is carried out, an instruction can be carried out to configure the destination of the facsimile server 21 from a menu (not shown in the drawings) or the like.

To configure the distribution destination, for example, the facsimile server 21 which is to be a distributor is selected, an instruction to carry out a configuration of the distribution destination is carried out, and a network apparatus which is to be configured as the distribution destination is selected. The order of each configuration process is not limited to what this example illustrates, and either one of the processes can be carried out first, or the processes can be carried out in any order. Alternatively, an order which is easy to operate can be configured at the time of design. The network apparatus can be selected one by one, or can be selected in groups by selecting a range (in FIG. 5, the range is shown by a dashed-lined rectangle). The selected icons can be displayed in a different form. For example, color or brightness of the icons can be changed. In FIG. 5, for the convenience of indicating by drawing, the selected icons are shown with hatchings. Moreover, in the example shown in FIG. 5, the terminal devices 14˜17 and the printer 22 are selected as the distribution destination. Different types of network apparatuses can be selected by the same operation, and the selected network apparatus can be configured as the distribution destination.

When the user instructs to carry out a configuration, a screen as shown in FIG. 6 as example for configuring a distribution condition is displayed on the display unit 31. Here, supposed that when the facsimile server 21 receives a facsimile, the received image is distributed in accordance with information obtained from the facsimile communication protocol or the like. From the screen for configuring a condition as shown in FIG. 6, it is configured under which condition the image will be distributed to the network apparatus selected on the screen shown in FIG. 5. In the example shown in FIG. 6, conditions can be configured for a Transmitting Subscriber Identification (TSI), subaddress (SUB), password (PWD) or the like in the communication protocol. As a specific example, if “0345678901” is configured as the TSI by a facsimile machine of a transmitter, only when receiving “0345678901” as the TSI at the reception of a facsimile, the received facsimile image is distributed to the network apparatus selected in FIG. 5.

The configuration unit 34 carries out a configuration of a distribution destination by configuring the condition, and operating a “set” button. At this time, information relating to the configured distribution destination is registered/updated as a part of the configuration information 36 stored in the memory unit 35. In addition, information of the network apparatus of the distribution destination, the distribution condition configured on the screen shown in FIG. 6, or the like are transmitted to the facsimile server 21 to carry out the configuration of the distribution destination.

As described above, the configuration of the distribution destination for the facsimile server 21 can be carried out at the central server 11. The network apparatus which is to be the distribution destination can be selected by a Graphical User Interface (GUI), which operation is extremely easy. Since the configuration and the registration with the facsimile server 21 are carried out automatically, the configuration can be carried out easily. In addition, since the configuration of the distribution destinations can be carried out under similar operations for various network apparatuses, for example, it can be configured to carry out a regular distribution to a terminal device, and a printer can be selected as a printing device of the received facsimile image by configuring the printer as a distribution destination.

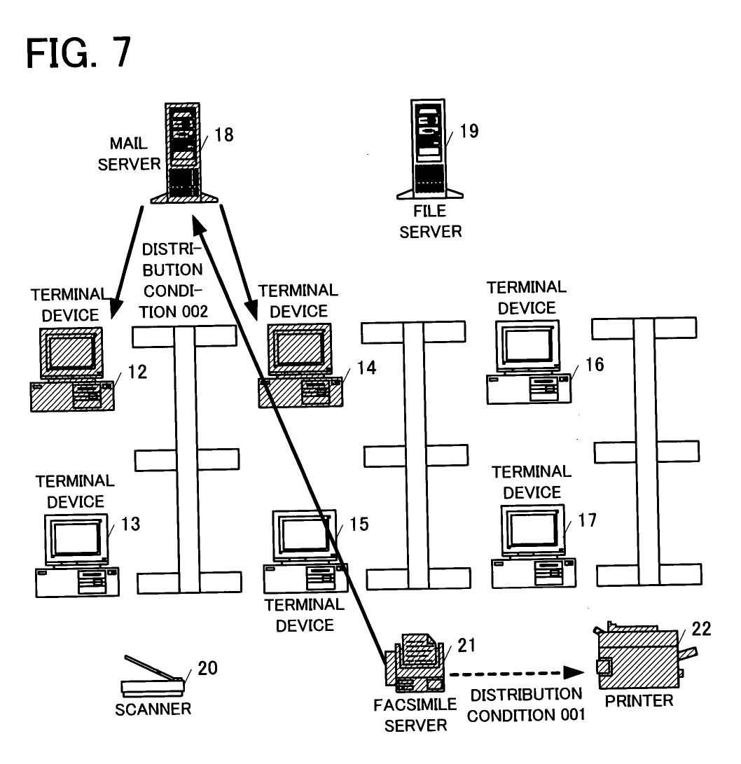

FIG. 7 shows an example of a display of distribution routes. After configuring the distribution destination of the facsimile server 21 as described above, when the facsimile server 21 receives a facsimile, the received facsimile image is distributed in accordance with the configured distribution condition. The distribution route can be confirmed by a display as shown in FIG. 7 as an example. In the example shown in FIG. 7, under a distribution condition “001”, it is configured to distribute to the printer 22, and it is shown to distribute directly from the facsimile server 21 to the printer 22.

Under a distribution condition “002”, it is configured to distribute to the terminal devices 12, 14, and it is shown to distribute from the facsimile server 21 to the terminal devices 12, 14 via the mail server 18 by using an electronic mail. For each of the distribution conditions, the route can be displayed in a different form. In the example shown in FIG. 7, arrow types are different. Moreover, various displaying methods can be applied. For example, the routes can be displayed in different colors. By referring to such a display, the above-described configuration of the distribution destination or the like can be carried out. Of course, a desired distribution destination can be configured by adding, deleting, or changing the distribution destination configured by the above-described configuration of the distribution destination.

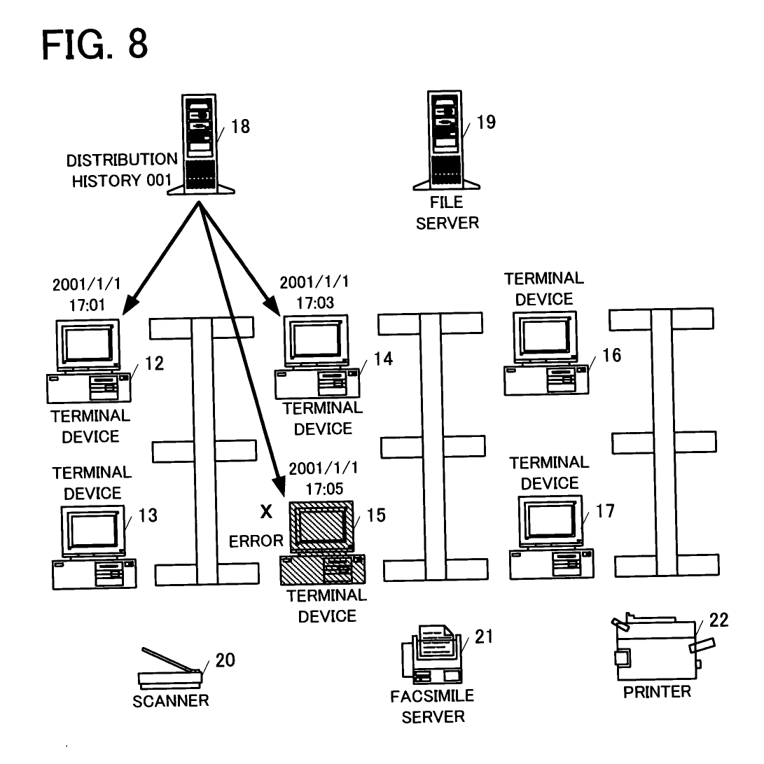

FIG. 8 shows an example of a display of a distribution history. After carrying out a configuration of the distribution destination as described above, when the information is actually distributed, the history of the distribution can be saved in the memory unit 35, and displayed. In the example shown in FIG. 8, the information (electronic mail) is distributed from the mail server 18 to the terminal devices 12, 14, 15. In this example, the distribution of the information to the terminal devices 12, 14 is completed normally. However, the same information failed to be distributed to the terminal device 15 due to a generation of an error. In the drawing, the terminal device 15 is shown with hatching, and an “X” is displayed to indicate the generation of the error. As described above, a generation of an error, indicating remaining undistributed information, or the like can be checked visually from the display of the distribution history.

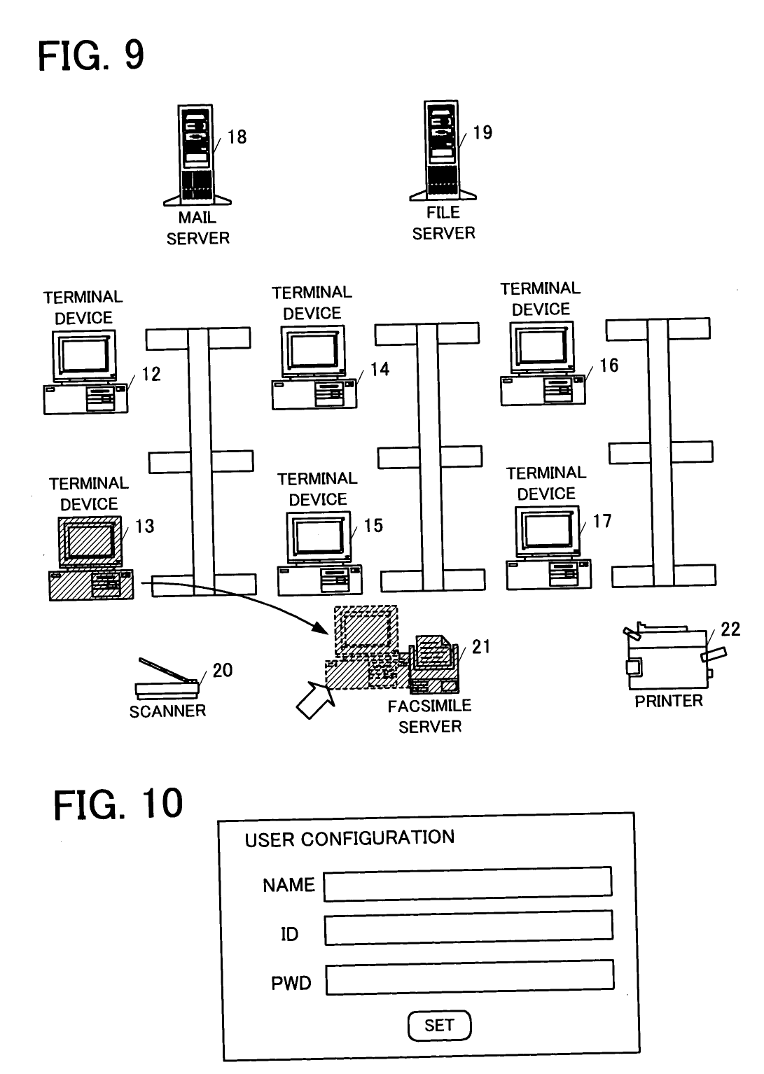

FIG. 9 shows an example of a display screen when registering a client. FIG. 10 shows an example of a screen for a user configuration when registering a client. Under a state in which a basic display as shown in FIG. 2 is carried out, a client can be registered with the facsimile server 21 by instructing from a menu (not shown in the drawings) or the like. When registering a client, for example, an icon corresponding to the network apparatus which is to be registered as a client can be dragged, and the icon can be dropped on the icon of the facsimile server 21 (drag and drop), to associate the network apparatus with the facsimile server 21. In the example shown in FIG. 9, the icon of the terminal device 13 is dragged and dropped on the icon of the facsimile server 21. Of course, when registering a plural number of network apparatuses as the client, a plural number of icons can be selected, and dragged and dropped on the icon of the facsimile server 21. The client is not limited to the terminal devices, and the scanner 20, the printer 22, the mail server 18, the file server 19 or the like can be registered as the client.

When an operation to associate the network apparatus with the facsimile server 21 is carried out, a screen for carrying out a user configuration as shown in FIG. 10 as an example is displayed on the display unit 31. In the example shown in FIG. 10, a user name (NAME), a user ID (ID), a password (PWD) or the like can be registered. After inputting these items, by operating a “set” button, the configuration unit 34 registers a client with the facsimile server 21. At this time, the information concerning the registration of the client is registered/updated as a part of the configuration information 36 stored in the memory unit 35. In addition, information of the network apparatus to be registered as a client, and information of the user configuration information registered on the screen shown in FIG. 10 are transmitted to the facsimile server 21, and a registration of a client is carried out.

As described above, the central server 11 can register a client with the facsimile server 21. The registration of the client can be carried out visually, thus making the operation extremely easy. Moreover, since the configuration and the registration with the facsimile server 21 are carried out automatically, the configuration can also be carried out easily.

In the above-described example, a client is registered with the facsimile server 21. Moreover, a client can be registered with the mail server 18 or the file server 19 in the same manner. For example, by associating a printer, a scanner or the like with a terminal device, a printer, a scanner or the like which can be used by the terminal device can be configured.

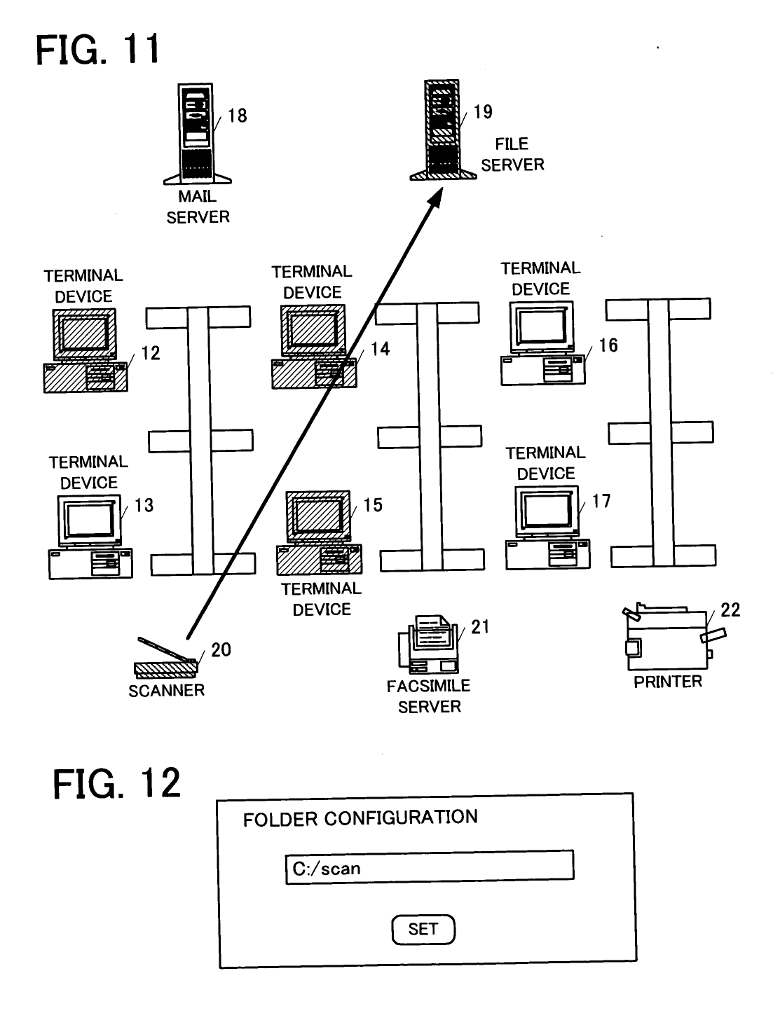

FIG. 11 shows an example of a display screen when configuring a storage device for a scanned original document. FIG. 12 shows an example of a screen for a folder configuration when assigning the storage device for the scanned original document. Under a state in which a basic display as shown in FIG. 2 is carried out, a storage device of image (scanned original document) scanned by the scanner 20 can be configured by instructing from a menu (not shown in the drawings) or the like. When carrying out a configuration of the storage device, for example, the scanner 20 and another network apparatus are associated.

In the example shown in FIG. 11, the scanner 20 and the file server 19 are associated. This association can be carried out by dragging and dropping the icon of the scanner 20 onto the icon of the file server 19, or dragging and dropping the icon of the file server 19 onto the icon of the scanner 20. When such an association is carried out, in the example shown in FIG. 11, an arrow is displayed between the icon of the scanner 20 and the icon of the file server 19 to show that the scanner 20 and the file server 19 are associated.

When an operation is carried out to associate the scanner 20 and the file server 19, for example, a screen for configuring a folder of a storage device as shown in FIG. 12 is displayed on the display unit 31. As a specific example, a folder “C:/scan” is configured in FIG. 12. When a folder is input and a “set” button is operated, the configuration unit 34 carries out a configuration of a storage device of the scanned original document to the scanner 20. Then, when necessary, the configuration unit 34 executes necessary processing, such as instructing the file server 19 to form a folder.

As described above, a storage device of the scanned original document scanned by the scanner 20 can be configured easily. Further, a network apparatus which can fetch a scanned original document can be configured by being registered as a client. For example, a client can be registered by dragging and dropping an icon corresponding to a network apparatus which is to be registered as the client, onto the icon of the scanner 20 or the file server 19. In the example shown in FIG. 11, the terminal devices 12, 14, 15 are registered as the clients, and a form of the icons is changed and displayed. The change in the display form of the icons is shown with hatchings for the convenience of indicating by drawing. The terminal devices 12, 14, 15 which are registered as the clients can fetch the scanned image from the “C:/scan” folder of the file server 19, or can receive the scanned image forwarded from the file server 19. Of course, several folders can be configured in the storage device, and the client can be registered for each of the folders.

In each of the above-described examples, when carrying out various management configurations in the central server 11, the instruction for various configurations is carried out from the central server 11 to relating network apparatuses. However, the present invention is not limited to this example, and the central server 11 can be inquired from all the network apparatuses, and each of the network apparatuses can carry out various operations such as distribution or printing in each of the network apparatuses.

Moreover, the configuration information 36 registered as described above, and the information of the layout image and the arranged icons or the like can be organized into files. Then, the files can be managed, forwarded, etc. In this case, any unit can be adopted as a unit for making a file. For example, the unit can be an entire management range of the central server 11, or each layout image, each group, or the like.

As described above, the management configuration of various types of network apparatuses can be carried out easily in the present invention with a unified display screen and operation. Of course, various management configurations other than the above-described examples can be carried out. For example, each of the icons can be selected, and an apparatus configuration or a user configuration of the network apparatus corresponding to the selected icon can be carried out.

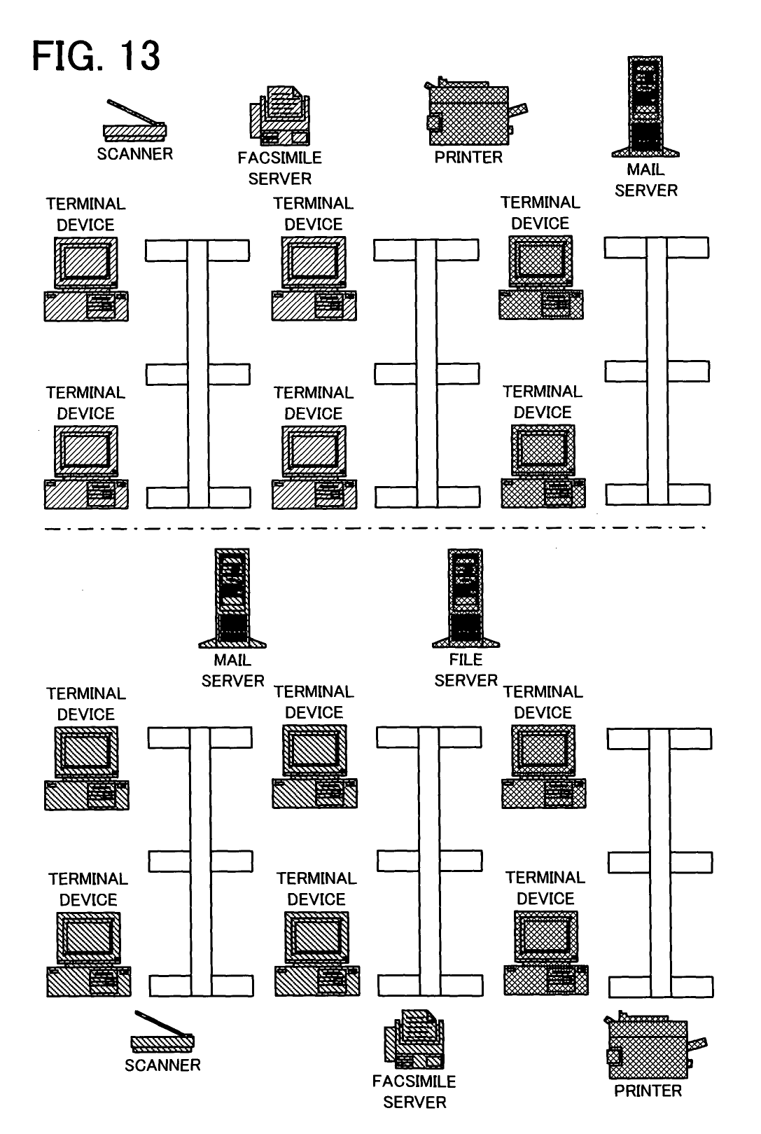

FIG. 13 shows an example of a screen for operating a management configuration between a plural number of layout images. As described above, icons corresponding to network apparatuses are provided in each of the layout images, allowing the network apparatuses to be managed. Furthermore, it is possible to carry out various management configurations between the layout images. In the example shown in FIG. 13, the layout image and the icons that were used in each of the above-descried examples are provided as a lower half, and other layout image and icons are provided as an upper half.

Under a state in which a plural number of layout images are displayed as in this example, in the example shown in FIG. 13, an operation for grouping is carried out, and a result of the grouping is displayed. In this example, the network apparatuses shown with cross-hatching belong to one group, and a group is configured over a plural number of layout images. Of course, the above-described client configuration and other various management configurations can be carried out.

Moreover, when the management configuration by a plural number of layout images is carried out, it is preferable to display a correlation between the layout images. Furthermore, for example, several central servers can be provided, the configuration information 36 managed by each of the central servers can be exchanged as deemed appropriate, and the operation of the management configuration can be carried out over a plural number of layout images.

What is claimed is:

1. A server device which manages various types of network apparatus, comprising:
a display unit;
a display control unit which arranges icons indicating a number of network apparatuses on a layout image, and displays the layout image on the display unit according to a configuration state;
an operation unit which accepts an operation by triggering icons by a user; and
a configuration unit which carries out a configuration of management information of the network apparatus in accordance with the operation.

2. The server device according to claim 1, wherein the configuration unit notifies a change in the configuration to each of relating network apparatuses according to the configuration of the management information carried out in accordance with the operation.

3. The server device according to claim 1, wherein the configuration unit configures a network apparatus corresponding to an icon selected in accordance with an operation to select a range of the icons, as a distribution destination of information.

4. The server device according to claim 1, wherein in accordance with an operation to associate an icon corresponding to a network apparatus with an icon corresponding to a server apparatus, the configuration unit carries out a configuration to register the network apparatus as a client of the server apparatus.

5. The server device according to claim 1, wherein the configuration unit carries out a configuration to group the network apparatus corresponding to the icons selected in accordance with the operation to select a range of icons.

6. The server device according to claim 5, wherein the display control unit changes a display form of the icons corresponding to the network apparatuses that belong to different groups based on the configuration of groups, and displays a plurality of groups at a same time.

7. The server device according to claim 1, wherein the display control unit can display a distribution route of the information on the display unit.

8. The server device according to claim 1, wherein the display control unit can display a distribution history of the information on the display unit.

9. A server device which manages various types of network apparatus, comprising:
means for displaying;
means for controlling contents to be displayed by the means for displaying by arranging icons which indicate the network apparatuses on layout image in according to a configuration state;
means for operating to accept an operation triggering icons by a user; and
means for configuring to carry out a configuration of management information of the network apparatuses in accordance with the operation.

10. The server device according to claim 9, further comprising:
means for notifying a change in the configuration to each of relating network apparatuses according to the configuration of the management information carried out in accordance with an operation.

11. The server device according to claim 9, wherein the means for configuring configures a network apparatus corresponding to an icon selected in accordance with an operation to select a range of icons, as a distribution destination of information.

12. The server device according to claim 9, wherein in accordance with an operation to associate an icon corresponding to a network apparatus with an icon corresponding to a server apparatus, the means for configuring carries out a configuration to register the network apparatus as a client of the server apparatus.

13. The server device according to claim 9, further comprising:
means for configuring to group the network apparatuses corresponding to the icons selected in accordance with the operation to select a range of icons.

14. The server device according to claim 13, wherein the means for controlling to display changes a display form of the icons corresponding to the network apparatuses that belong to different groups based on the configuration of groups, and displays a plurality of groups at a same time.

15. The server device according to claim 9, wherein the means for controlling to display can display a distribution route of the information.

16. The server device according to claim 9, wherein the means for controlling can display a distribution history of the information.

17. A method for managing network apparatus by a server device comprising:
arranging icons which indicate network apparatuses on layout image and displaying the layout image on a display unit according to a configuration state;
accepting an operation triggering icons by a user; and
configuring management information of the network apparatuses in accordance with the operation.

18. The method for managing according to claim 17, further comprising:
notifying a change in the configuration to each of relating network apparatuses according to the configuration of the management information carried out in accordance with the operation.

19. The method for managing according to claim 17, further comprising:
configuring a network apparatus corresponding to an icon selected in accordance with an operation to select a range of icons, as a distribution destination of information.

20. The method for managing according to claim 17, further comprising:
registering a network apparatus as a client of a server apparatus in accordance with an operation to associate an icon corresponding to the network apparatus with an icon corresponding to the server apparatus.
